(19) United States
(12) Patent Application Publication
(10) Pub. No.: US 2014/0067414 A1
(43) Pub. Date: Mar. 6, 2014

(54) SYSTEM FOR PROCESSING MEDICAL INFORMATION

(71) Applicant: Pusan National University Industry-University Cooperation Foundation, Busan (KR)

(72) Inventor: Byung Kwan CHOI, Busan (KR)

(73) Assignee: Pusan National University Industry-University Cooperation Foundation, Busan (KR)

(21) Appl. No.: 14/016,074

(22) Filed: Aug. 31, 2013

(30) Foreign Application Priority Data
Aug. 31, 2012 (KR) 10-2012-0096311
Aug. 28, 2013 (KR) 10-2013-0102310

(51) Int. Cl. G06Q 50/22; G06F 19/00

(52) U.S. Cl. CPC G06Q 50/22; G06F 19/3437
USPC 705/2

(57) ABSTRACT

Provided is a system for processing medical information. The system for processing medical information includes a spatial affected-part information generator configured to generate spatial affected-part information on a region designated by a user in a patient body map, and a medical patient information generator configured to generate medical patient information including the spatial affected-part information.

### CROSS-REFERENCE TO RELATED APPLICATION

This application claims priority to and the benefit of Korean Patent Application Nos. 10-2012-0096311, filed on Aug. 31, 2012 and 10-2013-0102310, filed on Aug. 28, 2013, the disclosures of which are incorporated herein by reference in its entirety.

### BACKGROUND

1. Field of the Invention

The present invention relates to medical information processing technology, and more particularly, to a system for processing medical information that expresses an affected region of a patient using spatial information.

2. Discussion of Related Art

With the development of computer technology, attempts are being made to process medical information using a computer in the medical field. One of the attempts is a method of coding medical concepts or terms as codes that can be used in a computer. A typical example of such a medical code system is International Classification of Diseases (ICD)-10. ICD-10 is a medical classification list in which various diagnoses are coded using combinations of letters and numbers, and used to classify diseases. Besides ICD 10, there are various medical code systems such as ICD-9, Unified Medical Language System (UMLS), Systematized Nomenclature of Medicine-Clinical Terms (SNOMED CT), and so on.

However, existing medical code systems have a problem in that no good location relationship has been established between respective codes indicating medical terms (or concepts). For example, in ICD 10, a position of an affected part indicated by D12.0 may be intuitively thought to be closer to a position of an affected part indicated by D11.0 than a position of an affected part indicated by D16.8. However, D12 indicates a benign rectal tumor, D16.8 indicates a benign coccygeal tumor, and D11.0 indicates a salivary gland tumor. In other words, the affected part indicated by D12.0 is far closer to the position of the affected part indicated by D16.8 than the position of the affected part indicated by D11.0. In this way, in existing medical code systems, it is impossible to intuitively know a relationship between respective codes.

In addition, existing medical code systems (or medical terminology systems) have a problem in that they cannot accurately and minutely express medical information generated in various actual medical environments. For example, concepts of the degrees of cuts of a spinal bone may be classified into total laminectomy, subtotal laminectomy, partial laminectomy, and so on. However, in various operations, the three classifications of the degrees of cut of a spinal bone totally lack the accuracy of expression, and are dependent on subjective judgments of doctors, such that the degrees cannot be accurately expressed.

With recent developments of medical science and diagnostic systems employing computed tomography (CT), magnetic resonance imaging (MRI), etc., it is possible to very minutely check a position of an affected part of a patient, a portion removed through an operation, etc., but medical terminology systems (or medical code systems) for expressing medical information, such as a position of an affected-part, the extent of an operation, and an operation state of a patient cannot support the medical science and the diagnostic systems. For this reason, it is impossible to input medical information that is generated in an actual medical environment due to advancing medical technology using an expression recognizable by a digital processing system such as a computer, and it is also impossible to exchange the medical information with other hospitals.

For example, blood pressure is measured by wrapping a band for measuring blood pressure around a patient's arm. Here, depending on a position of an arm at which a cuff is wrapped to make the measurement, a measured blood pressure value may vary. However, using conventional medical terminology systems, it is impossible to minutely express the position at which the cuff has been wrapped. Thus, when only the measured blood pressure value is delivered from one hospital to another hospital, it is impossible to accurately know a detailed blood pressure state of the patient.

Meanwhile, when a medical code system is upgraded with the development of medical technology, there are many cases in which a predetermined code (or concept) disappears or is replaced by another code (or concept). In the process of upgrading the medical code system, a problem such as loss of medical information or destruction of the meaning of medical information occurs.

### SUMMARY

The inventive concept is directed to providing a medical information processing system capable of accurately and minutely expressing various types of medical information generated in various medical environments.

According to an aspect of the inventive concept, there is provided a system for processing medical information including: a spatial affected-part information generator configured to generate spatial affected-part information on a region designated by a user in a patient body map; and a medical patient information generator configured to generate medical patient information on a predetermined patient including the spatial affected-part information.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a constitution of a system for processing medical information according to an exemplary embodiment of the present invention;

FIG. 2 is a diagram schematically illustrating a state in which a spatial affected-part information generator according to an exemplary embodiment of the present invention generates spatial affected-part information from a patient body map;

FIG. 3 is a diagram of a first exemplary embodiment in which a spatial affected-part information generator of the present invention generates spatial affected-part information from a patient body map;

FIG. 4 is a diagram illustrating a state in which a spatial affected-part information generator of the present invention generates spatial affected-part information using spatial data about a reference point representing an affected region and mapping data about the spatial data;

FIG. 5 is a diagram of a two-dimensional (2D) patient body map of a stomach among internal organs of a body;

FIG. 6 is a diagram illustrating a state of generating spatial affected-part information on a cylindrical structure in a body;

FIG. 7 is a diagram illustrating a state in which a spatial affected-part information generator of the present invention generates spatial affected-part information on an affected region of a predetermined patient using an affected-part model;

FIG. 8 is a diagram illustrating a state of extracting a medical term mapped to a spatial body region in an exemplary embodiment of the present invention;

FIG. 9 is a diagram of an exemplary embodiment in which a medical patient information generator of the present invention generates medical patient information using spatial affected-part information;

FIG. 10 is a diagram of another exemplary embodiment in which a medical patient information generator of the present invention generates medical patient information using spatial affected-part information;

FIG. 11 is a diagram of still another exemplary embodiment in which a medical patient information generator of the present invention generates medical patient information using spatial affected-part information;

FIG. 12 is a diagram of yet another exemplary embodiment in which a medical patient information generator of the present invention generates medical patient information using spatial affected-part information;

FIG. 13 is a diagram illustrating a state in which a medical patient information generator generates medical patient information using only spatial affected-part information when a tumor occurs on the surface of a bodily organ;

FIG. 14 is a diagram illustrating a state in which a medical patient information generator generates medical patient information using only spatial affected-part information when the thumb of a left hand has been cut off;

FIG. 15 is a diagram for comparing a spine with scoliosis in a patient body map and a normal spine in a body map;

FIG. 16 shows diagrams of a patient body map displayed at view angles set for the patient body map on a screen by a display of the present invention;

FIG. 17 is a diagram illustrating a state in which a searcher of the present invention enlarges a region of interest around an affected part to check an organ around the affected part; and

FIG. 18 is a diagram illustrating a state in which a medical terminology converter according to an exemplary embodiment of the present invention converts medical patient information into medical terms.

### DETAILED DESCRIPTION OF EXEMPLARY EMBODIMENTS

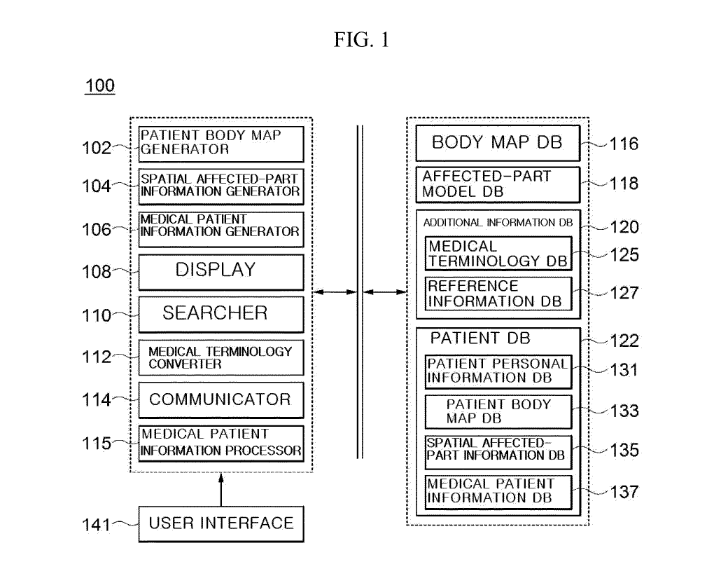

Hereinafter, detailed embodiments of a system for processing medical information in accordance with the present invention will be described with reference to FIG. 1 to FIG. 18. However, the embodiments are merely examples and are not to be construed as limiting the present invention.

When it is determined that the detailed description of known art related to the present invention may obscure the gist of the present invention, the detailed description thereof will be omitted. Terminology described below is defined considering functions in the present invention and may vary according to a user's or operator's intention or usual practice. Thus, the meanings of the terminology should be interpreted based on the overall context of the present specification.

The spirit of the present invention is determined by the claims, and the following exemplary embodiments are provided only to efficiently describe the spirit of the present invention to those of ordinary skill in the art.

FIG. 1 is a block diagram showing a constitution of a system for processing medical information according to an exemplary embodiment of the present invention.

Referring to FIG. 1, a system 100 for processing medical information includes a patient body map generator 102, a spatial affected-part information generator 104, a medical patient information generator 106, a display 108, a searcher 110, a medical terminology converter 112, a communicator 114, a medical patient information processor 115, a body map database 116, an affected-part model database 118, an additional information database 120, and a patient database 122. Here, the additional information database 120 includes a medical terminology database 125 and a reference information database 127. Also, the patient database 122 includes a patient personal information database 131, a patient body map database 133, a spatial affected-part information database 135, and a medical patient information database 137.

The patient body map generator 102 generates a patient body map of a predetermined patient. In this specification, patients include a potential or preliminary patient (a general individual who is likely to be ill) as well as a patient who is suffering from a disease and visits a hospital. In addition, patients may include a virtual patient (a patient created in a virtual environment such as a medical simulation program, a graphic program, or so on). The patient body map expresses physical and anatomical information on the patient (e.g., the digestive system, the nervous system, the circulatory system, the musculoskeletal system, muscles, and bones) in a two-dimensional (2D) or three-dimensional (3D) virtual space. For example, a patient body map expresses physical and anatomical information on a patient in various coordinate systems such as a Cartesian coordinate system, a plane oblique coordinate system, a plane polar coordinate system, a 3D Cartesian coordinate system, a 3D oblique coordinate system, a cylindrical coordinate system, and a spherical coordinate system.

The patient body map generator 102 may generate a patient body map of the entire body, or a patient body map of a part of the body. The patient body map generator 102 may store one or more patient body maps of each patient in the patient body map database 133. The patient body map generator 102 may store all patient body maps or only some of patient body maps in the patient body map database 133. Also, the patient body map generator 102 may store patient body maps in the patient body map database 133 according to, for example, organs, affected regions, diseases, and periods (times).

The patient body map generator 102 may generate a patient body map of a predetermined patient using, for example, 1) images of the patient or 2) an existing body map. These cases will be described in detail below.

(1) Case of Generating a Patient Body Map Using Images of a Patient

The patient body map generator 102 may generate a 3D patient body map by processing a plurality of 2D images obtained by photographing a patient using a medical imaging system, for example, a computed tomography (CT) scanner, a magnetic resonance imaging (MRI) scanner, or a positron emission tomography (PET) scanner. In general, when a tomography scan is performed on a patient using CT, MRI, PET, etc., a 2D image of an xy plane is obtained. Here, by continuously photographing a patient from the head to the toes along the z axis using CT, MRI, PET, etc., a plurality of 2D images of the xy plane can be obtained from the head to the toes. Then, by performing image processing to connect the plurality of 2D images of the xy plane from the head to the toes, it is possible to generate a 3D patient body map of the whole body of the patient.

(2) Case of Generating a Patient Body Map Using an Existing Body Map

The patient body map generator 102 may generate a patient body map of a predetermined patient using a body map stored in the body map database 116. A body map expresses physical and anatomical information on a person of a specific body type expressed in a 2D or 3D virtual space. In the body map database 116, body maps may be stored according to sex (i.e., male or female), age, height (i.e., stature), residential district (or country), anatomical variation, and so on. Anatomical variation denotes anatomical differences that are not caused by a disease but are observed in normal bodies. For example, in the case of the middle cerebral artery, anatomical variation may occur in the number of branches. Half the general public have three branches, one fifth of the general public have two branches, another fifth of the general public have four branches, and the rest have five branches. Since a potential (or preliminary) patient and a virtual patient do not have medical images, the patient body map generator 102 may generate patient body maps using a body map stored in the body map database 116.

In the body map database 116, body maps of body parts as well as whole bodies may be stored. Although a size ratio or relationship between bodily organs or pieces of bodily tissue in a generated body map may be the same as that of an actual body, the body map is not limited to the same size ratio or relationship as that of the actual body, and may briefly depict physical and anatomical information on the body. A body map may be a 3D body map or a 2D body map. Each body map may be matched with a unique identification number (or code) and stored. In this case, body maps may be shared and exchanged among medical institutions or countries. In this way, when a unique identification number (or code) is given to each body map, the body map can be standardized and used among respective medical institutions or countries.

The patient body map generator 102 checks patient information, such as the sex, age, height, residential district, and anatomical variation of a patient, and then may extract a body map corresponding to the patient information from the body map database 116 to generate a patient body map. In this case, the extracted body map is that which expresses physical and anatomical information on the patient most similarly. For example, a doctor may generate a patient body map by extracting a body map corresponding to patient information on a patient under diagnosis from the body map database 116. A general individual who is a potential (or preliminary) patient may generate a patient body map by extracting a body map corresponding to personal information on himself or herself from the body map database 116. A doctor may create a virtual patient in a virtual environment on a computer, and then generate a patient body map by extracting a body map corresponding to the virtual patient from the body map database 116.

The patient body map generator 102 may generate a patient body map by modifying the extracted body map according to the patient. For example, when the patient has six fingers on his or her left hand, the patient body map generator 102 may generate a patient body map by modifying a left hand part of the extracted body map according to the patient. When the middle cerebral artery of the patient has five branches, but there are three branches in the extracted body map, a body map part in which the middle cerebral artery has five branches is additionally extracted and then combined with the previously extracted body map, such that a patient body map may be generated.

In addition, the patient body map generator 102 may select a body map that is most similar to the physical and anatomical information on the patient in the body map database 116 using the patient information, and use the selected body map itself as a patient body map of the patient. In this case, the patient body map is identical to the body map in the database 116

As described above, in this specification, an operation in which the patient body map generator 102 generates a patient body map includes all cases of generating a patient body map 1) by using an image of a patient, 2) by modifying a body map, 3) by combining multiple body maps, and 4) by extracting and using a body map as it is. In other words, in this specification, a patient body map includes all of a newly generated patient body map, a patient body map obtained by modifying an existing body map, a patient body map obtained by combining existing body maps, an existing body map used as it is as a patient body map, and so on. Here, when an existing body map is used as it is, a patient body map may be the original body map itself.

The spatial affected-part information generator 104 generates spatial affected-part information on a region designated by a user (e.g., a doctor) in a patient body map. The spatial affected-part information may denote an affected region designated by the user in the patient body map using spatial coordinate information. For example, the spatial affected-part information may denote spatial coordinate information on an affected region in the patient body map expressed using a point, lines, a surface, a triangle, a rectangle, a polygon, a pixel, a voxel, volumes, an equation (sphere, ellipsoid, etc.), a 3D figure, a 3D mesh, a combination thereof, or a relationship thereamong. To express the affected region, for example, an equation, a vector, an array, a matrix, and a determinant may be used. Here, the affected region does not mean only a part in which a disease has actually occurred, but also includes a region of interest of the user (e.g., a position that is not the affected region but in which blood pressure is measured, a position from which blood is collected, a region related to the affected region, a region incised during an operation, a region sutured during an operation, an auscultated region, a palpated region, a ligated region, a region observed by a doctor, and so on). The spatial affected-part information may include a unique identification number (or code) of the patient body map used to generate the spatial affected-part information. The spatial affected-part information generator 104 may display the generated spatial affected-part information on a screen through the display 108.

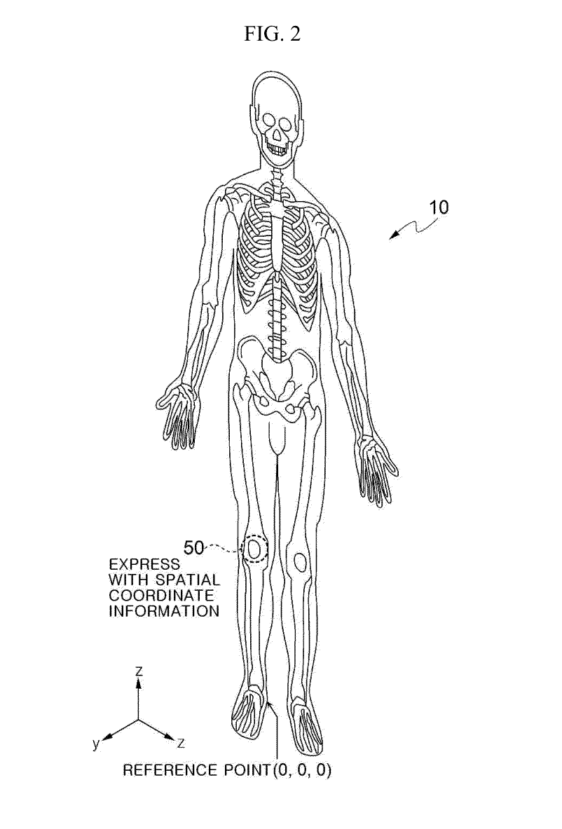

FIG. 2 is a diagram schematically illustrating a state in which a spatial affected-part information generator according to an exemplary embodiment of the present invention generates spatial affected-part information from a patient body map. Referring to FIG. 2, the spatial affected-part information generator 104 may generate spatial affected-part information on a region 50 designated by a user (i.e., an affected region) in a patient body map 10. For example, when the right heel in the patient body map 10 is set as a reference point, the user-designated region 50 may be indicated by spatial coordinate information on the basis of the reference point. Although it has been described above that the reference point is the right heel, the reference point is not limited thereto, and points other than the right heel (e.g., the top of the head, an eye, the nose, the mouth, the navel, and the anus) may be set as the reference point. The spatial coordinate information may include one-dimensional (1D) coordinate information, 2D coordinate information, and 3D coordinate information. From spatial affected-part information, it is possible to accurately know the position, depth, size, area, volume, etc. of an affected region in a patient body map in detail.

The spatial affected-part information generator 104 may store generated spatial affected-part information in the spatial affected-part information database 135 according to patients. However, storage of the spatial affected-part information is not limited to the spatial affected-part information database 135, and the spatial affected-part information generator 104 may store the generated spatial affected-part information in the affected-part model database 118. When spatial affected-part information generated from an affected region of a predetermined patient is stored as an affected-part model, the affected-part model may be applied to another patient having an affected region that is the same as or similar to the affected region of the predetermined patient. Also, the spatial affected-part information generator 104 may store the generated spatial affected-part information in the spatial affected-part information database 135 according to, for example, times (periods), organs, affected parts, and clinical departments.

Here, in the patient body map displayed on the screen, the user may designate at least one affected region through a user interface 141. Then, the spatial affected-part information generator 104 generates spatial affected-part information on the region designated by the user, and presents the region designated by the user using spatial coordinate information. The user interface 141 is a tool that receives and delivers a command of a user to the medical information processing system 100, for example, a mouse or a keyboard.

Using various mathematical operators and programming operators, for example, unions, intersections, complementary sets, AND, OR, NOT, addition, subtraction, multiplication, division, enlargement, reduction, rotation, positional movement, determinants, matrix transformation, if, true, false, <, >, ≦, ≧, &&, special symbols for a string, and strings, the spatial affected-part information generator 104 may generate spatial affected-part information on the affected region.

For example, when the affected region is the head and the left arm, the user may designate a head region X and a left arm region Y in the patient body map through the user interface 141, and then input a calculation command for obtaining a union of the two regions. In this case, the spatial affected-part information generator 104 may generate spatial affected-part information on the affected regions denoted by (X∪Y). Here, the operator “∪” may be replaced by another sign (or string or strings) to express the same concept. For example, using “union” or “@” instead of “∪,” (X∪Y) may be expressed as “X union Y” or “X @ Y.” The spatial affected-part information may include not only the affected-part spaces (regions) denoted by (X∪Y) but also the corresponding operation expression, that is, (X∪Y). However, the spatial affected-part information is not limited to both of the affected-part spaces and the corresponding operation expression, and may include only the corresponding operation expression. In other words, the spatial affected-part information may not include information on all spatial coordinates of the affected regions denoted by (X∪Y), but may include the operation expression (X∪Y) itself. Here, an operation expression includes not only a mathematical operator and a programming operator, but also includes a string, a programming language, a database field, a query, etc. denoting the meaning of the operation expression even if no operator is used.

The spatial affected-part information generator 104 may store only the spatial affected-part information on the affected regions denoted by (X∪Y) in a separate storage space (e.g., the affected-part model database 118). In this case, the spatial affected-part information generator 104 may extract and use spatial affected-part information on the corresponding affected regions without the operation expression.

Meanwhile, in a patient body map, a predetermined affected region (e.g., head) includes numerous vertices and surfaces constituting the affected region. Here, when the numerous vertices and surfaces are expressed as spatial information, a large amount of data is generated. Therefore, spaces such as a head region and a left arm region are defined in the patient body map in advance, and then the corresponding affected region is expressed using a union of the predefined head region and the predefined left arm region, such that the amount of data can be remarkably reduced. When spatial affected-part information is generated using an operator in this way, it is possible to minimize the amount of stored data and also simply express a complex affected region.

A detailed method for the spatial affected-part information generator 104 to generate spatial affected-part information on a region designated by the user will be described below. However, a method for the spatial affected-part information generator 104 to generate spatial affected-part information is not limited to the method to be described below, and spatial affected-part information can be generated through various methods other than the method to be described below.

### Exemplary Embodiment 1

The spatial affected-part information generator 104 may generate spatial affected-part information on a region (i.e., an affected region) presented using a figure input by a user through the user interface 141, a combination of two or more figures, or a relationship among two or more figures in a 3D patient body map displayed on the screen. In other words, the user may designate an affected region of a patient in a patient body map displayed on the screen using a figure, a combination of two or more figures, or a relationship among two or more figures. For example, the user may designate an affected region of a patient using figures, such as a sphere, a cylinder, an elliptic cylinder, an elliptic cone, a pyramid, a tetrahedron, an octahedron, a dodecahedron, and an icosahedron, a combination thereof, or a relationship among them. However, the types of figures are not limited to these, and various types of figures other than them can be used.

For example, when the user designates an affected region using a figure called a sphere, the user may designate the affected region by inputting central point coordinates (x, y, z) of the sphere and a radius r of the sphere through the user interface 141. In this case, the spatial affected-part information generator 104 may generate spatial affected-part information on the affected region expressed as the sphere.

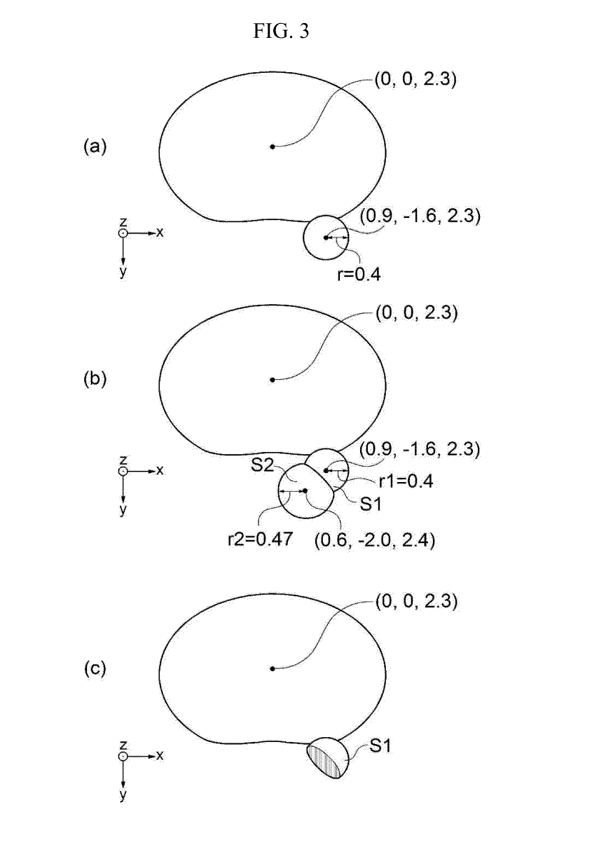

FIG. 3 is a diagram of a first exemplary embodiment in which a spatial affected-part information generator of the present invention generates spatial affected-part information from a patient body map. Here, a case of designating an affected region in connection with a disc between 4^{th} and 5th lumbar vertebrae is illustrated. Since plan views of the disc between 4^{th} and 5th lumbar vertebrae are shown, all points of the views have the same z coordinate. The center of a structure of the disc is set as a reference point.

Referring to (a) of FIG. 3, the user may designate a point at which a lumbar herniated nucleus pulposus has occurred by inputting an x coordinate and a y coordinate through the user interface 141. For example, when an affected region has a spherical shape, the user may express the affected region with central point coordinates (x, y, z) of a sphere and a radius r of the sphere. Here, the affected region may be expressed as (x, y, z, r). For example, when coordinates of a central point of the affected region are (0.9, −1.6, 2.3), and a radius of the affected region is 0.4, the affected region may be expressed as (0.9, −1.6, 2.3, 0.4). Alternatively, the affected region may be expressed as “(0.9, −1.6, 2.3) size (0.4).” When a unique identification number (or code) of a patient body map is #hu1428, spatial affected-part information may be expressed as “(0.9, −1.6, 2.3, 0.4) by map #hu1428.” Here, the spatial coordinates are in accordance with an organic coordinate system (i.e., local coordinate system) of an organ in which the affected part is present. The organic coordinate system may be substituted with a whole-body coordinate system presenting the whole body of a patient.

Referring to (b) of FIG. 3, when an affected region has a snowman shape, the affected region may be designated by combining two spheres having the same radius or different radiuses. The affected region may be expressed as a union of a first sphere S1 having central point coordinates (x1, y1, z) and a radius r1 and a second sphere S2 having central point coordinates (x2, y2, z) and a radius r2. In other words, the affected region may be expressed as (x1, y1, z, r1)∪(x2, y2, z, r2). For example, when central point coordinates of the first sphere S1 are (0.9, −1.6, 2.3), a radius of the first sphere S1 is 0.4, central point coordinates of the second sphere S2 are (0.6, −2.0, 2.4), and a radius of the second sphere S2 is 0.47, the affected region may be expressed as (0.9, −1.6, 2.3, 0.4) ∪(0.6, −2.0, 2.4, 0.47). In this case, since the affected region can be expressed using only the central point coordinates of the two spheres and the radiuses of the two spheres, it is possible to efficiently express spatial affected-part information while reducing the amount of data.

Referring to (c) of FIG. 3, when an affected region has a shape obtained by removing the second sphere S2 from the combination of the first sphere S1 and the second sphere S2, the affected region may be expressed as (x1, y1, z, r1)∩(x2, y2, z, r2)^{C}. When the name of a database field including the affected region is “inclusion_model,” and the name of a database field excluding the affected region is “exclusion_model,” the same concept may be expressed by storing (x1, y1, z, r1) in the field titled “inclusion_model” and (x2, y2, z, r2) in the field titled “exclusion_model.”

Although a case in which the spatial affected-part information generator 104 forms a figure using an equation according to an input of a user, and generates spatial affected-part information on an affected region expressed as the figure has been described herein as an example, the spatial affected-part information generator 104 is not limited to this case, and may form a figure using a mesh or a polygon according to an input of a user and generate spatial affected-part information on an affected region expressed as the figure. For example, a user may load a patient body map into a graphic program such as 3D studio max, and AutoCAD, and then designate an affected region in the patient body map. The graphic programs provide a unit figure such as a mesh or a polygon. A user may form a figure using the mesh or polygon to designate an affected region, and the spatial affected-part information generator 104 may generate spatial affected-part information on the affected region.

In this way, when an affected region is designated using unit figures such as a mesh and a polygon, spatial affected-part information may include spatial data about all points constituting the unit figures and data about a relationship among the respective points. However, spatial affected-part information is not limited to both of the spatial data and the relationship data, and may only include spatial data about at least one reference point (e.g., a central point of the affected region) representing the affected region among pieces of spatial data about all points constituting the affected region and mapping data presenting a relationship between the reference points and the affected region. In this case, it is possible to simply express the affected region with only the spatial data about the reference points and the mapping data.

In the spatial affected-part information database 135, spatial data about a whole affected region in accordance with spatial affected-part information may be stored, and spatial data about a reference point representing the affected region may be mapped to the affected region and stored. In other words, the spatial affected-part information generator 104 may set spatial data about a whole affected region designated by a user as spatial affected-part information, or set spatial data about a reference point representing the affected region designated by the user and mapping data as spatial affected-part information. Here, the spatial affected-part information generator 104 may map the spatial data about the whole affected region designated by the user to the spatial data about the reference point representing the affected region, and store the mapped spatial data in the spatial affected-part information database 135.

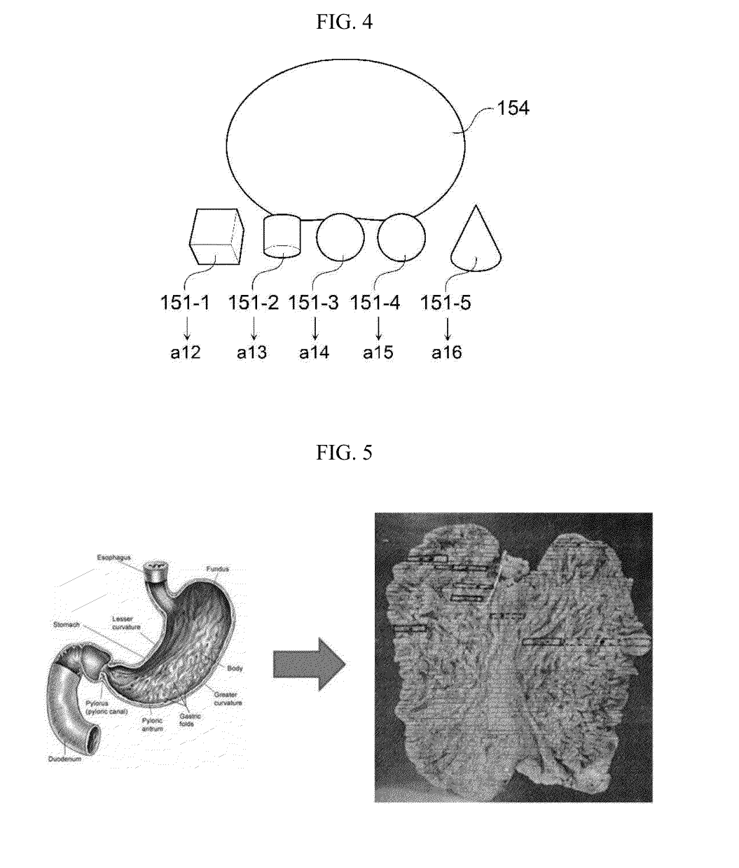

FIG. 4 is a diagram illustrating a state in which a spatial affected-part information generator of the present invention generates spatial affected-part information using spatial data about a reference point representing an affected region and mapping data about the spatial data.

Referring to FIG. 4, each of several affected parts 151-1, 151-2, 151-3, 151-4 and 151-5 having various shapes, sizes and positions near a spinal disc 154 may be expressed using spatial data about reference points and mapping data about the spatial data. Here, the reference points of the respective affected parts 151-1, 151-2, 151-3, 151-4 and 151-5 may be central points of the respective affected parts 151-1, 151-2, 151-3, 151-4 and 151-5. The spatial data about the reference points is coordinate values of the central points of the respective affected parts 151-1, 151-2, 151-3, 151-4 and 151-5. To the respective affected parts 151-1, 151-2, 151-3, 151-4 and 151-5, codes, for example, a12, a13, a14, a15 and a16, may be given, respectively. To the respective codes a12, a13, a14, a15 and a16, the spatial data (i.e., position information) about the reference points of the respective affected parts 151-1, 151-2, 151-3, 151-4 and 151-5 and information on the shapes, sizes, etc. of the respective affected parts 151-1, 151-2, 151-3, 151-4 and 151-5 may be mapped.

### Exemplary Embodiment 2

The spatial affected-part information generator 104 may generate spatial affected-part information on a region (i.e., affected region) designated by a user in a 2D patient body map displayed on the screen. In other words, according to an affected region, a patient body map may be generated in a 2D plane. For example, when an affected region is on a surface of a part of his or her body whose cross sections can be displayed or spread (e.g., brain cortex, viscus internal organs, a heart, the retina of an eyeball, and spinal cord), a patient body map may be generated in a 2D plane.

FIG. 5 is a diagram of a 2D patient body map of a stomach among internal organs of a body. Referring to FIG. 5, a user may designate an affected region in a patient body map displayed on the screen using points, lines, a plane (2D figures, for example, a rectangle, a triangle, a circle, an ellipse, a pentagon, and a hexagon), a combination thereof, or a relationship thereamong through the user interface 141. The combination of figures or the relationship thereamong may be expressed using a mathematical operator and a programming operator. When the user wants to designate an affected region using a figure called a rectangle, the user may designate the affected region by inputting coordinates (x, y) of one vertex of the rectangle and horizontal and vertical lengths of the rectangle.

Then, the spatial affected-part information generator 104 generates spatial affected-part information on the region designated by the user in the 2D patient body map. At this time, the spatial affected-part information generator 104 may generate the spatial affected-part information by substituting the region designated by the user with 3D spatial coordinates. In other words, since the 2D patient body map is obtained by spreading a body part of a 3D space in a 2D plane, the spatial affected-part information generator 104 may substitute and present the region designated by the user in the 2D patient body map with 3D spatial coordinates again. However, the spatial affected-part information generator 104 is not limited to 3D spatial coordinates, and may generate spatial affected-part information that is 2D spatial coordinates for the region designated by the user in the 2D patient body map.

### Exemplary Embodiment 3

When an affected part is in a body structure consisting of several layers (e.g., a layered structure of blood vessels, a layered structure of skin, a layered structure of the heart, and a layered structure of the brain cortex), the spatial affected-part information generator 104 may generate spatial affected-part information including a depth of the affected part according to an input of a user. For example, when cancer occurs in a body structure consisting of several layers, it is necessary to present a layer and a depth to which the cancer has spread. Here, the user may designate the corresponding affected region in a patient body map through the user interface 141, and also designate a depth of the affected part in a cross section of the affected region. Then, when spatial affected-part information on the affected region designated by the user is generated, the spatial affected-part information generator 104 includes depth information on the affected part in the spatial affected-part information.

### Exemplary Embodiment 4

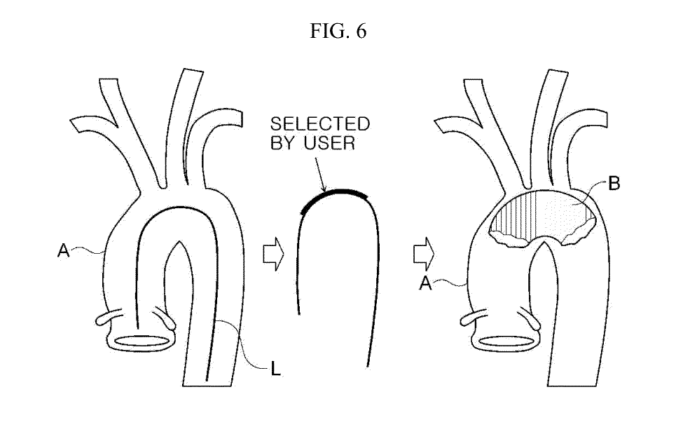

When a virtual line passing through a center of a cylindrical structure in a body (e.g., fingers, toes, arms, legs, blood vessels, and nerves) is formed, and then a user designates an affected part by selecting a part of the virtual line, the spatial affected-part information generator 104 may generate spatial affected-part information on a whole cylindrical structure region corresponding to the partial virtual line selected by the user. FIG. 6 is a diagram illustrating a state of generating spatial affected-part information on a cylindrical structure in a body. Referring to FIG. 6, in the case of a cylindrical structure such as a blood vessel A in a body, the spatial affected-part information generator 104 may form a virtual line L passing through a center of the blood vessel A. Subsequently, when a user selects a part or the whole of the virtual line L through the user interface 141, the spatial affected-part information generator 104 generates spatial affected-part information on a whole cylindrical structure region B corresponding to the selected part or whole of the virtual line L.

### Exemplary Embodiment 5

The spatial affected-part information generator 104 may generate spatial affected-part information on an affected region of the corresponding patient by extracting a predetermined affected-part model from the affected-part model database 118 and then modifying the extracted affected-part model according to the patient. The affected-part model database 118 stores an affected region having a fixed shape and size as an affected-part model for each disease or illness. The affected-part model database 118 may store spatial information on an affected region having a shape and a size of an affected-part that is frequently observed from the corresponding disease or illness. For example, the affected-part model database 118 may store an affected region having an affected-part shape and size that are frequently observed from a disease or an illness, such as stomach cancer, a stomach ulcer, herniated nucleus pulposus, a burn, a nerve tumor, and acne, as an affected-part model. At this time, a unique identification number (or code) may be given to each affected-part model, and stored with the affected-part model. Since a unique identification number (or code) is given to each affected-part model, it is possible to exchange or share the affected-part model among doctors, hospitals, and countries without constraint. Also, an affected-part model may be mapped to at least one medical term and stored. When an affected-part model is mapped to a medical term, it is possible to readily find the affected-part model by inputting the medical term. Each user may register an affected-part model that he or she wants to use with the affected-part model database 118. In the affected-part model database 118, spatial data about a reference point representing each affected-part model may also be mapped to the affected-part model and stored.

Specifically, the spatial affected-part information generator 104 may generate spatial affected-part information on an affected region of the corresponding patient by extracting an affected-part model selected by a user from the affected-part model database 118 and then rotating the extracted affected-part model or modifying a shape, size, etc. of the affected-part model according to the affected region. Although it has been described herein that the spatial affected-part information generator 104 modifies the extracted affected-part model according to the corresponding affected region, spatial affected-part information is not limited to the modified affected-part model, and spatial information on the extracted affected-part model may be used as spatial affected-part information. For example, when a predetermined affected-part model is the same as the corresponding affected region, the spatial affected-part information generator 104 may extract spatial information on the corresponding affected-part model from the affected-part model database 118, and use the extracted spatial information as spatial affected-part information. Also, the spatial affected-part information generator 104 may extract spatial data about at least one reference point representing a predetermined affected-part model and mapping data presenting a relationship between the reference point and the affected-part model from the affected-part model database 118, and use the extracted data as spatial affected-part information on the corresponding patient.

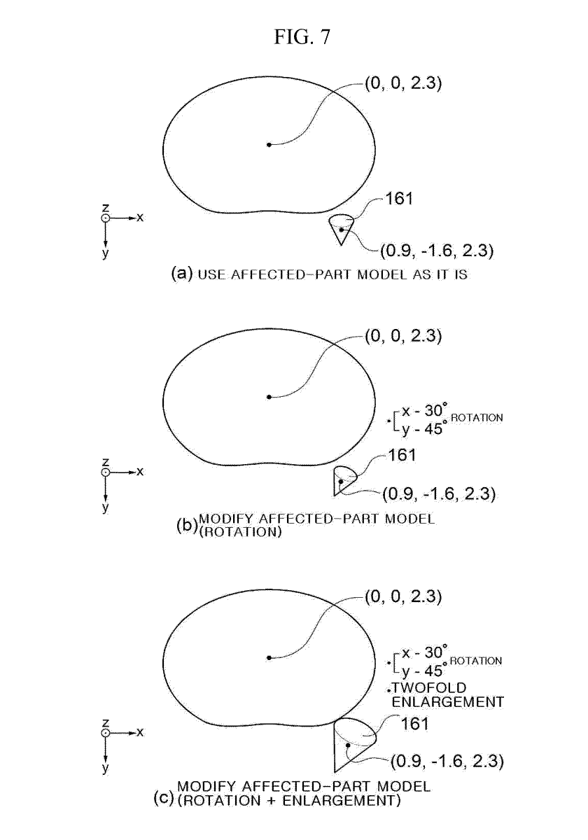

FIG. 7 is a diagram illustrating a state in which a spatial affected-part information generator of the present invention generates spatial affected-part information on a predetermined affected region using an affected-part model. Here, a case of designating an affected region in connection with a disc between 4^{th} and 5^{th} lumbar vertebrae is illustrated. Since plan views of the disc between lumbar vertebrae numbers 4 and 5 are shown, all points of the views have the same z coordinate.

Referring to (a) of FIG. 7, when an affected part is a fragment of a disc in the form of a spike, the spatial affected-part information generator 104 may extract an affected-part model 161 (e.g., an affected-part model having a unique identification number (or code) of E1212) in the form of a spike from the affected-part model database 118 according to a command of a user. The spatial affected-part information generator 104 may display the extracted affected-part model 161 at a position of the affected part on the screen. The user may designate the extracted affected-part model 161 as an affected region as it is. The affected region may be expressed using the unique identification number (or code) of the affected-part model 161 and central point coordinates of the affected region. For example, an affected region may be presented as E1212 (0.9, −1.6, 2.3).

Referring to (b) of FIG. 7, the spatial affected-part information generator 104 may generate spatial affected-part information on the affected region by rotating the affected-part model 161 according to a command of a user. For example, when the affected-part model 161 is rotated 30 degrees about an x axis and 45 degrees about a y axis, the affected region may be presented as E1212 (0.9, −1.6, 2.3) & rotation (30, 45, 0).

Referring to (c) of FIG. 7, the spatial affected-part information generator 104 may generate spatial affected-part information on the affected region by rotating and enlarging (or reducing) the affected-part model 161 according to a command of a user. For example, when the affected-part model 161 is rotated 30 degrees about the x axis and 45 degrees about the y axis, and enlarged twofold, the affected region may be presented as {E1212 (0.9, −1.6, 2.3)}×2 & rotation (30, 45, 0).

The medical patient information generator 106 may generate medical patient information on the corresponding patient including spatial affected-part information. The medical patient information generator 106 may generate medical patient information on the corresponding patient by combining spatial affected-part information and additional information. The medical patient information generator 106 may display the generated medical patient information on the screen through the display 108. The medical patient information generator 106 may store generated medical patient information in the medical patient information database 137 according to respective patients.

Here, the additional information includes at least one of information on an affected part of a patient, information presenting a state and degree of illness of the affected part, and information directly or indirectly (subsidiarily) related to treatment for the affected part. The additional information may include at least one of a medical term (or medical code) and reference information. The additional information may be stored in the additional information database 120 in advance. The medical term (or medical code) may be stored in the medical terminology database 125 in the additional information database 120. The reference information may be stored in the reference information database 127 in the additional information database 120. Medical terms (or medical codes), reference information and medical patient information will be described below.

Medical terms (or medical codes) include medical terms (or medical codes) defined in conventional medical terminology systems (e.g., International Classification of Diseases (ICD)-9, ICD-10, Unified Medical Language System (UMLS), and Systematized Nomenclature of Medicine-Clinical Terms (SNOMED CT)), or medical terms that have not been defined in the conventional medical terminology systems. Medical terms that have not been defined in the conventional medical terminology systems may be used in the form of narrative text. For example, a medical term registered with ICD 10 for a cold is “acute nasopharyngitis.” However, terms that have not been defined in conventional medical terminology systems, such as “cold,” “bad cold,” “upper respiratory infection,” and “cold with myalgia,” may also be used. Medical terms may be, for example, partial regions of a body, causes of diseases, diseases, findings, symptoms, diagnoses, anatomical names, structures of tissue, drugs, names of organs, names of tissue, substances such as viruses and bacteria, treatment drugs, operation methods, specific points in time (or time slots), occurrence of diseases, occurrence of accidents, operations, childbirth, death, parts of a body for adjusting a function or parts whose functions are adjusted, genes, substances, elements, molecules, speed, mass, temperature, concentration, and so on. However, medical terms are not limited to these, and various other medical terms may be included.

In the medical terminology database 125, certain medical terms may be mapped to predetermined spatial body regions and stored. For example, when a spatial body region denotes a stomach, medical terms such as stomach that is the name of the organ, names of tissues, functions of a stomach, symptoms of trouble, operations, operation methods, and treatment drugs may be mapped to the spatial body region called the stomach. When spatial affected-part information denotes the stomach, the medical patient information generator 106 may generate medical patient information by combining medical terms, such as the name of the organ, names of tissues, functions of the stomach, symptoms of trouble, operations, operation methods, and treatment drugs, with spatial medical-part information.

A medical term “K29.7 (gastritis unspecified)” of ICD 10 denotes an inflammation occurring in the stomach, and thus may be mapped to the spatial body region called the stomach. Likewise, a medical term “C16.9” denotes stomach cancer, and thus may be mapped to the spatial body region called the stomach. A medical term “544710916” of SNOMED CT denotes an anatomical structure called the stomach, and thus may be mapped to the spatial body region called the stomach. In this way, since predetermined medical terms are mapped to predetermined spatial body regions and stored in the medical terminology database 125, when a user designates a predetermined region of interest in a patient body map, it is possible to extract a medical term mapped to the region of interest.

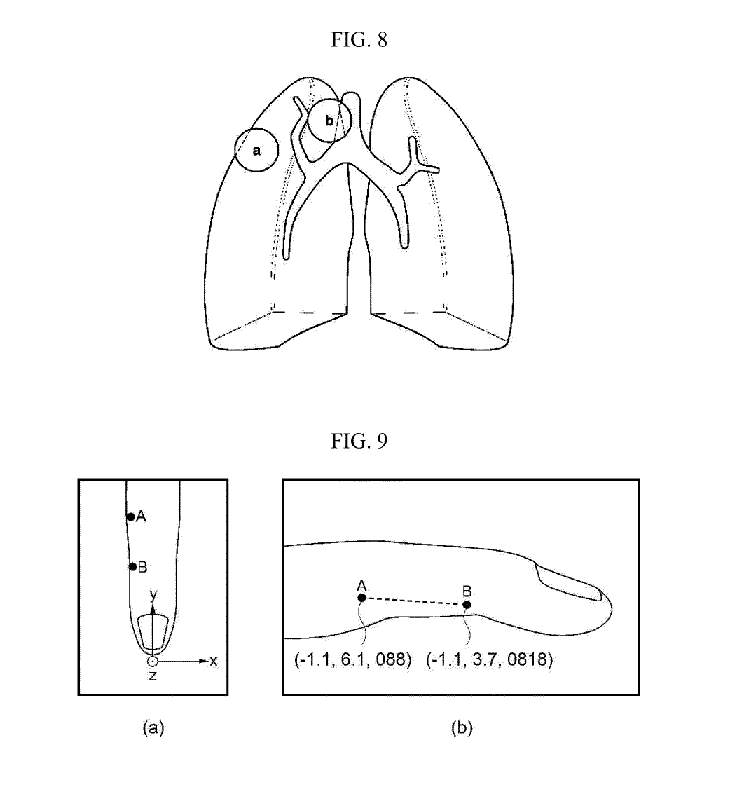

FIG. 8 is a diagram illustrating a state of extracting a medical term mapped to a spatial body region in an exemplary embodiment of the present invention.

Referring to FIG. 8, when a user selects a region a as a region of interest, the region a partially overlaps lung parenchyme, and thus the medical patient information generator 106 may extract medical terms such as SNOMED 564437013 (entire lung), SNOMED 6636015 (right lung), J12.9 (viral pneumonia, unspecified), and J12.0 (adenoviral pneumonia) from the medical terminology database 125. When a user selects a region b as a region of interest, the region a partially overlaps the lung parenchyma and the trachea, and thus the medical patient information generator 106 may extract medical terms such as SNOMED 564434018 (entire trachea) and D14.2 (Benign neoplasm of trachea) in addition to SNOMED 564437013 (entire lung), SNOMED 6636015 (right lung), J12.9 (viral pneumonia, unspecified), and J12.0 (adenoviral pneumonia) from the medical terminology database 125.

Meanwhile, a medical term mapped to a spatial body region may be used to set spatial affected-part information through calculation with other spatial information. For example, spatial affected-part information may be set using a union or an intersection of a medical term mapped to a spatial body region and other spatial information. However, spatial affected-part information is not limited to this, and may be set by rotating or shifting a spatial body region designated by a medical term (i.e., medical term mapped to the spatial body region) through matrix transformation.

Reference information denotes information whereby a doctor or a patient can be aided in connection with a predetermined spatial body region. Reference information may be mapped to a predetermined spatial body region and stored in the reference information database 127. Reference information may be, for example, types of illnesses that may occur in the spatial body region, types of examinations on the spatial body region, a geographic location at which a disease (e.g., infectious disease) of the spatial body region has occurred, surrounding tissue that may be affected by an operation, complication of an operation, medical magazines, medical papers, and newspaper articles related to the spatial body region, hospitals, doctors, and treatment drug stores for an illness occurring in the spatial body region, whether or not the corresponding illness can be covered by insurance, a medical dictionary, an effects of a drug, a side effect of a drug, a place at which examination material is collected, a diagnosis instrument, a part of the body to which a medical instrument is attached, a motion direction and a rotation direction of parts of the body, a sequence in which a motion occurs in attachments of muscles, an intranet or Internet address (uniform resource locator (URL) or link information), a program (or application) on a computer to which the medical information processing system is applied, and so on. However, reference information is not limited to these, and there may be various types of reference information other than these.

Medical patient information is generated to include at least one of spatial affected-part information and additional information, and denotes all medical information generated in connection with the corresponding patient. Items of medical patient information may be, for example, symptom, chief complaint, physical examination, sign, diagnosis, cause of a disease, past history, operation name or procedure name, treatment plan, examination results, admission record, discharge record, operation record, status record, nursing record, and so on. However, medical patient information is not limited to these, and besides these, various types of medical information generated in relation to the patient may be included.

Among cases of generating medical patient information, there may be a case in which a doctor generates spatial affected-part information on a patient under diagnosis through the medical information processing system 100, and generates medical patient information including the spatial affected-part information. Also, there may be a case in which a doctor generates spatial affected-part information on a virtual affected part of a virtual patient through the medical information processing system 100, and generates medical patient information including the spatial affected-part information. Further, there may be a case in which a general individual who is a potential (or preliminary) patient generates spatial affected-part information on his or her potential affected part through the medical information processing system 100, and generates medical patient information including the spatial affected-part information.

### Exemplary Embodiments of Medical Patient Information

(1) Symptom and Chief Complaint

A symptom is the content of a complaint “Somewhere in my body hurts in some way,” given by a patient to a doctor. Here, content corresponding to an anatomical part “somewhere in my body” may be presented using spatial affected-part information, and content “hurts in some way” may be presented using additional information.

(2) Physical Examination or Sign

While a symptom is a complaint of a patient, a sign is a finding of a patient made by a doctor. Here, the doctor expresses description on the finding “There is certain finding in a certain part of body.” Content corresponding to an anatomical part “certain part of a patient's body” may be presented using spatial affected-part information, and content “certain finding” may be presented using additional information. For example, when the doctor auscultates the chest and hears a wheezing sound at a certain part of lung, the doctor conventionally writes “wheezing sound on left upper anterior chest” in a treatment record. On the other hand, when a position at which the wheezing sound is heard is (1, 12, 123) in patient body map hu1213, the medical patient information generator 106 may present the content corresponding to the anatomical part “certain part of the body” using spatial affected-part information, that is, (1, 12, 123) in map hu1213. Also, the content certain trouble” may be presented using additional information “sign: wheezing sound.” By combining the spatial affected-part information and the additional information, medical patient information may be expressed as “sign: wheezing sound on (1, 12, 123) in map hu1213.”

(3) Diagnosis

A diagnosis denotes the name of a disease of a patient inferred from a symptom and a physical examination. Since a diagnosis also may be expressed as “There is certain disease in a certain part of the body,” the anatomical meaning of “certain part of the body” may be presented using spatial affected-part information, and “certain disease” may be presented using additional information.

(4) Cause of Disease

Causes of diseases include bacteria, viruses, fungi, foreign substances (e.g., coins, dust, stones, and cleaners), and so on. In general, specific bacteria cause a disease in a specific bodily organ. For example, brain abscesses are mainly caused by Staphylococcus aureus, and also caused by a strain such as Streptococcus intermedius. When a position and a size of brain abscess are (1.92, 1.68, 3.2) size 3 in patient body map #hu153, the medical patient information generator 106 may present an anatomical part and a size of the disease (i.e., brain abscess) using spatial affected-part information, that is, (1.92, 1.68, 3.2) size 3 in map #hu153. Also, a case of the disease may be presented using additional information “Brain abscess caused by Staphylococcus aureus.” By combining the spatial affected-part information and the additional information, medical patient information may be expressed as “Brain abscess caused by Staphylococcus aureus at (1.91, 1.68, 3.2) size 3 in map #hu153.” Here, when a unique identification number (or code) “BA1382038” is given to “(1.91, 1.68, 3.2) size 3 in map #hu153” that is the spatial affected-part information, and a unique identification number (or code) “SA” is given to “Staphylococcus aureus” that is the cause of the disease, the medical patient information may be simply expressed as “Brain abscess BA1382038-SA.”

(5) Past History

A past history denotes a disease that a patient had in the past. For example, when a patient had nephritis during a certain time period in the past, an anatomical part “kidney” may be presented using spatial affected-part information, and “inflammation” and “the time period of nephritis” may be presented using additional information.

(6) Operation Name or Procedure Name

When a doctor performs an operation on a patient, an anatomical part undergoing the operation may be presented using spatial affected-part information, and a type of the operation may be presented using additional information.

FIG. 9 is a diagram of an exemplary embodiment in which a medical patient information generator of the present invention generates medical patient information using spatial affected-part information. Here, a case in which an affected part of a patient is a finger is illustrated. (a) of FIG. 9 is a top-down view of the finger of the patient, and (b) is a side view of the finger of the patient.

Referring to FIG. 9, when an operation of making an incision from A point to B point in the finger of the patient is performed, the medical patient information generator 106 may present the anatomical part undergoing the operation (i.e., from A point to B point) using spatial affected-part information, for example, “from (−1.1, 6.1, 0.88) to (−1.1, 3.7, 0.81) by map #hu 1872.” A local coordinate system has been used for the coordinate values, and a center of a fingertip of the patient has been set as a reference point (0, 0, 0). A type of the operation may be presented using additional information “incision.” By combining the spatial affected-part information and the additional information, medical patient information may be presented as “incision was done from (−1.1, 6.1, 0.88) to (−1.1, 3.7, 0.81) by map #hu 1872.” When a unique identification number (or code) “E18278398” is given to the spatial affected-part information and the operation type, the medical patient information may be simply expressed as “E18278398 was done.”

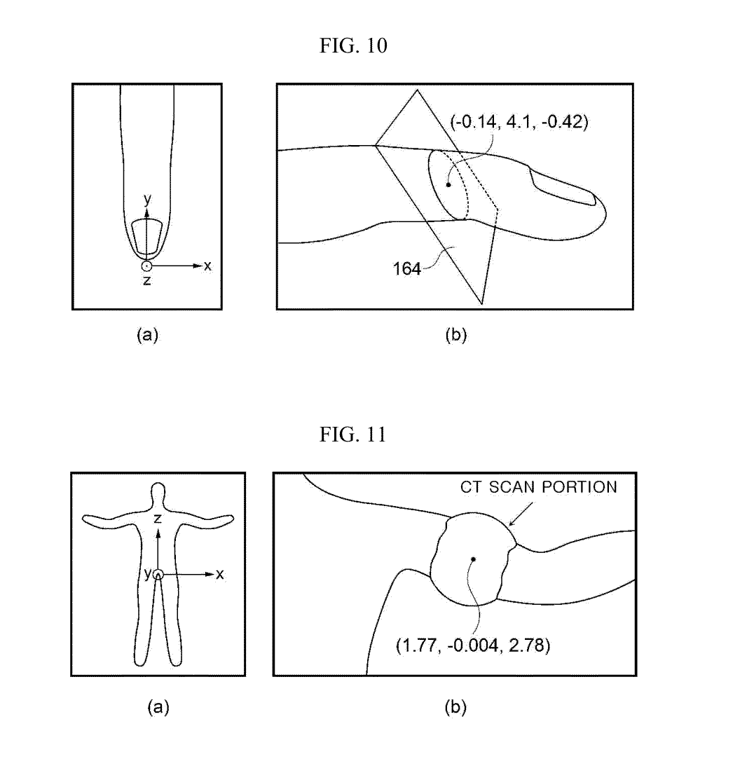

Meanwhile, when an operation of cutting off a finger of a patient is performed as illustrated in FIG. 10, spatial affected-part information on the patient may be presented using a cutting plane 164 whereby the finger is cut off. Here, the spatial affected-part information may be presented as center coordinates (−0.14, 4.1, −0.42) of the cutting plane 164. The center coordinates of the cutting plane 164 may be set to be a center of a cut surface of the finger. Specifically, the center coordinates (−0.14, 4.1, −0.42) of the cutting plane 164 is set as a reference point, and a relationship between the reference point and the corresponding affected region may be presented using mapping data. The medical patient information generator 106 may present the anatomical part having undergone the operation using spatial affected-part information, for example, (−0.14, 4.1, −0.42) by map #hu 1872, and the operation type using additional information “amputation.” By combining the spatial affected-part information and the additional information, medical patient information may be presented as “amputation (−0.14, 4.1, −0.42) by map #hu 1872.” The medical patient information may be expressed using a medical term and the spatial affected-part information. For example, by combining a medical code “76956004” having the meaning of “amputation of finger” in SNOMED with the spatial affected-part information “(−0.14, 4.1, −0.42) by map #hu 1872,” the medical patient information may be expressed as “76956004 at (−0.14, 4.1, −0.42) by map #hu 1872.”

(7) Treatment Plan

A treatment plan denotes a plan of an examination and an operation to be performed in the future to cure an illness of a patient. For example, a doctor may make a treatment plan, such as a part of the patient's body to be examined, examination equipment used for the examination, and a type of the examination. Here, the part of the patient's body may be presented using spatial affected-part information, and the examination equipment and the type of the examination may be presented using additional information.

FIG. 11 is a diagram of another exemplary embodiment in which a medical patient information generator of the present invention generates medical patient information using spatial affected-part information. (a) of FIG. 11 is a patient body map showing a whole body of a patient, and (b) of FIG. 11 is an enlarged view of an affected region of the patient in (a) of FIG. 11.

Referring to FIG. 11, when there is a plan to perform a CT scan on an upper part of the patient's left arm using a contrast medium, the medical patient information generator 106 may present the body part on which a CT scan will be performed using spatial affected-part information, for example, “(1.77, −0.004, 2.78) size 0.44 by map #hu 1392.” A local coordinate system has been used for the coordinate values, and a center of the patient's crotch has been set as a reference point (0, 0, 0). Additional information “CT scan using a contrast medium” may be presented as “CT with contrast.” By combining the spatial affected-part information and the additional information, medical patient information may be presented as “CT with contrast at (1.77, −0.004, 2.78) size 0.44 by map #hu 1392.”

(8) Examination Results

When a doctor measures blood pressure of a patient, a position of a blood pressure-measuring band may be presented using spatial affected-part information, and a blood pressure value may be presented using additional information. When various blood tests are performed, an anatomical position such as a body part for a blood sampling may be presented using spatial affected-part information, and a blood sampling time and place may be presented using additional information. Also, when certain tissue is removed and examined, the tissue may be presented using spatial affected-part information, and the biopsy results may be presented using additional information.

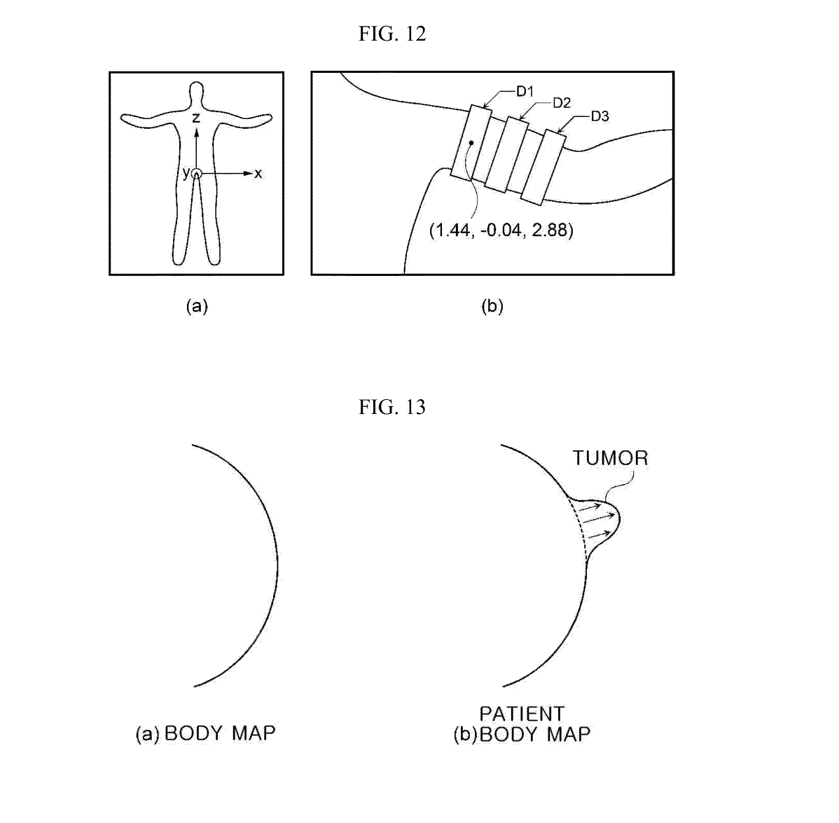

FIG. 12 is a diagram of still another exemplary embodiment in which a medical patient information generator of the present invention generates medical patient information using spatial affected-part information. (a) of FIG. 12 is a patient body map showing a whole body of a patient, and (b) of FIG. 12 is an enlarged view of an affected region of the patient in (a) of FIG. 12.

Referring to FIG. 12, when blood pressure is measured in the patient's left arm using a cuff, the medical patient information generator 106 may present a body part D1 in which the blood pressure is measured using spatial affected-part information, for example, (1.44, 0.04, 2.88) by map #hu 1392. A whole-body coordinate system has been used for the coordinate values, and a center of the patient's crotch has been set as a reference point (0, 0, 0). Additional information “blood pressure measurement using a cuff” may be presented as “blood pressure measurement using cuff method.” By combining the spatial affected-part information and the additional information, medical patient information may be presented as “blood pressure measurement using cuff method at (1.44, 0.04, 2.88) by map #hu 1392.” The medical patient information may be expressed using a medical term and the spatial affected-part information. For example, by combining a medical code “371911009” having the meaning of “blood pressure measurement using cuff method” in SNOMED with the spatial affected-part information “(1.44, 0.04, 2.88) by map #hu 1392,” the medical patient information may be expressed as “371911009 at (1.44, 0.04, 2.88) by map #hu 1872.” Meanwhile, the blood pressure of the patient may vary according to a position in the patient's left arm at which the blood pressure is measured. In other words, when the blood pressure is measured at different positions D1, D2 and D3 in the body, the measurement results may differ from each other. Thus, by presenting the positions D1, D2 and D3 in the body at which the blood pressure have been measured using spatial affected-part information, it is possible to generate medical patient information that is accurate and easy to share.

In an exemplary embodiment of the present invention, spatial affected-part information is included in medical patient information, and thus the medical patient information can replace or complement a medical term (or medical code) in accordance with a conventional medical terminology system. In other words, many existing medical terms have been defined in connection with parts of the body. Here, a portion of the meaning of a certain medical term designating a part of the body (e.g., anatomical content) may be expressed using spatial affected-part information, and the other portions (e.g., descriptive content about an affected part such as characteristics and a type of an illness) may be expressed using additional information.

In this way, in conventional medical terminology systems, such as ICD, UMLS, SNOMED CT, code on dental procedures and nomenclature (CDT), classification of death and injury resulting from terrorism, current procedural terminology (CPT)®, diagnosis-related groups (DRGs), diagnostic and statistical manual of mental disorders (DSM), healthcare common procedure coding system (HCPCS), healthcare cost and utilization project (HCUP), health level seven (HL7), international classification of functioning, disability and health (ICF), logical observation identifier names and codes terminology (LOINC)®, newborn screening coding and terminology guide, and RxNorm (medication codes), in which no spatial information is included, anatomical concepts such as a position, a shape, and a size in medical terms are replaced with spatial affected-part information and combined with additional information to generate medical patient information, and thus it is possible to intuitively know a spatial relationship between medical terms. For example, an anatomical concept “stomach” in a medical term “gastritis” that means an inflammation of the stomach may be expressed using spatial affected-part information, and “inflammation” may be expressed using additional information.

The medical patient information generator 106 may generate medical patient information on the corresponding patient by 1) using spatial affected-part information alone or 2) combining spatial affected-part information and additional information. Here, the medical patient information includes the spatial affected-part information, and thus may replace a conventional medical terminology system, or may be used to complement a conventional medical terminology system. The medical patient information generator 106 may give a unique identification number (or code) to a part (e.g., the spatial affected-part information or the additional information) or the whole of the medical patient information. The medical patient information corresponding to the unique identification number (or code) may be mapped to the unique identification number (or code) and stored.

(1) Case of Generating Medical Patient Information Using Spatial Affected-Part Information Alone

The medical patient information generator 106 may generate medical patient information according to results of a comparison between spatial affected-part information on an affected region of a patient and spatial information on a body region corresponding to the affected region in a body map. At this time, the medical patient information generator 106 may extract a body map corresponding to patient information, such as the sex, age, height, residential district, and anatomical variation of the patient, from the body map database 116, and then compare the spatial affected-part information on the affected region of the patient and the spatial information on the region corresponding to the affected region in the extracted body map.

### Exemplary Embodiment 1

When it is presented as a result of examining a patient that a tumor (or wen) has arisen in a certain bodily organ, the spatial affected-part information generator 104 may generate spatial affected-part information on a region designated by a user (i.e., a region in which the tumor has arisen) in a patient body map. At this time, by comparing a part of the patient body map in which the tumor (or wen) has arisen with the corresponding body region in a body map (e.g., a body map that corresponds to patient information and in which the corresponding body region is normal among body maps stored in the body map database 116), the medical patient information generator 106 can find that the tumor (or wen) has arisen in the corresponding portion of the bodily organ from the spatial affected-part information because the part of the patient body map in which the tumor (or wen) has arisen is not present in the corresponding body region of the body map.

In other words, when a tumor arises on a surface of a bodily organ as shown in FIG. 13, by comparing a part of a patient body map in which the tumor has arisen with the corresponding body region in a body map, it is possible to see that points corresponding to the part of a patient body map in which the tumor has arisen are shifted from the surface of the bodily organ in the body map to the outside according to a shape of the tumor. In this case, with spatial affected-part information alone, the medical patient information generator 106 may generate medical patient information that a tumor has arisen at a specific position on the corresponding bodily organ. Here, when the fact that a tumor has arisen on the bodily organ is expressed using the spatial affected-part information, it is possible not only to know the simple fact that a tumor has arisen on the bodily organ, but also to know accurate information on a position at which the tumor has arisen, a direction in which the tumor has grown, a size of the tumor, etc.

### Exemplary Embodiment 2

When a thumb of a patient's left hand is cut off, the spatial affected-part information generator 104 may generate spatial affected-part information on a region designated by a user (e.g., the left hand) in a patient body map. At this time, by comparing the left hand from which the thumb has been cut off in the patient body map with a left hand in a body map (e.g., a body map that corresponds to patient information and in which the corresponding body region is normal among body maps stored in the body map database 116), the medical patient information generator 106 can find that the thumb of the left hand has been cut off from the spatial affected-part information on the left hand because a part of the body map in which the thumb is present is not in the patient body map.

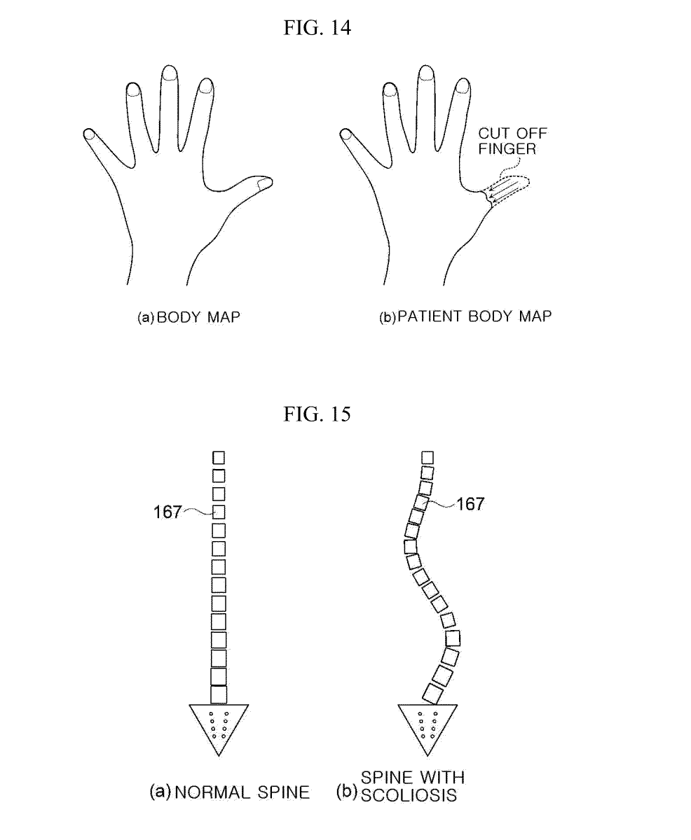

In other words, when a thumb of a left hand is cut off as shown in FIG. 14, by comparing a thumb part of the left hand in a patient body map with the corresponding body region in a body map, it is possible to see that vertices corresponding to the thumb part of the left hand in the patient body map are shifted from an outline of the corresponding body region in the body map to the inside according to a shape of the cut thumb of the left hand. In this case, with spatial affected-part information alone, the medical patient information generator 106 may generate medical patient information that the thumb of the patient's left hand has been cut off. Like this, when a certain part (e.g., a finger, a toe, an ear, a hand, or a foot) of the body is cut off, it is possible to generate medical patient information with only spatial affected-part information on the corresponding body part.

In addition, when a certain organ in the body is attached to or fused with another organ (e.g., fusion between lumbar vertebral bodies, or fusion between a tibia and calcaneus), by comparing an affected region in a patient body map with the corresponding body region in a body map (e.g., a body map that corresponds to patient information and in which the corresponding body region is normal among body maps stored in the body map database 116), the medical patient information generator 106 can generate medical patient information that the corresponding organs have been attached to each other from only spatial affected-part information on the corresponding body parts because, while the corresponding organs are apart from each other in the body map, they have been attached to each other in the affected region of the patient body map. Similarly, even when a part of body fractures, a certain organ in body splits, etc., it is possible to generate medical patient information with only spatial affected-part information on the corresponding body part.

### Exemplary Embodiment 3

When a patient has scoliosis, the spatial affected-part information generator 104 may generate spatial affected-part information on a region designated by a user (e.g., spine) in a patient body map. When the spine with scoliosis in the patient body map is compared with a spine in a body map (e.g., a body map that corresponds to patient information and in which the corresponding body region is normal among body maps stored in the body map database 116), vertebrae of the spine with scoliosis in the patient body map have been shifted compared to the normal spine in the body map.

FIG. 15 is a diagram for comparing a spine with scoliosis in a patient body map and a normal spine in a body map. Referring to FIG. 15, the medical patient information generator 106 may generate medical patient information about in which direction and how much a spine of a patient has been curved from only spatial affected-part information about how much respective spinal segments 167 in a patient body map ((b) of FIG. 15) have been shifted with respect to respective spinal segments 167 of a normal spine ((a) of FIG. 15).

(2) Case of Generating Medical Patient Information by Combining Spatial Affected-Part Information and Additional Information

The medical patient information generator 106 may generate medical patient information on the corresponding patient by combining spatial affected-part information and additional information extracted from the additional information database 120 according to a command of a user. The medical patient information generator 106 may generate the medical patient information by combining at least one piece of spatial affected-part information and at least one piece of additional information. Here, the additional information includes at least one of a medical term and reference information.

### Exemplary Embodiment 1

When a doctor diagnoses a patient and determines a herniated disc between lumbar vertebrae numbers 1 and 2 as an illness of the patient, the spatial affected-part information generator 104 may generate spatial affected-part information on a region designated by the user (i.e., the disc between 1^{st} and 2nd lumbar vertebrae) in a patient body map. The medical patient information generator 106 may extract a medical term “herniation” from the additional information database 120 according to a command of the user, and then combine the spatial affected-part information with “herniation,” thereby generating a diagnosis “herniated disc between lumbar vertebrae numbers 1 and 2” as medical patient information. In this case, it is possible to accurately and minutely express a position of the affected part of the patient with the medical patient information. Also, with the spatial affected-part information, it is possible to accurately and minutely express an affected-part state of the patient such as in which direction and how much the disc between 1^{st} and 2^{nd} lumbar vertebrae has protruded.

In other words, according to ICD 10 that is a conventional medical terminology system, a herniated disc between lumbar vertebrae may be expressed as a disease classification code M51.0. However, there are several discs between lumbar vertebrae numbers 1 and 2, 2 and 3, 3 and 4, and 4 and 5, between a lumbar vertebra number 5 and a sacrum number 1, etc. according to the parts, it is impossible to express in detail where a herniated disc has occurred, in which state a herniated disc is, etc. with the code M51.0 alone. On the other hand, in an exemplary embodiment of the present invention, spatial affected-part information is included in medical patient information, such that a position and a state of an affected part can be accurately and minutely expressed.

### Exemplary Embodiment 2

When a doctor diagnoses a patient and determines a pneumonia having occurred in a part of the lungs as an illness of the patient, the spatial affected-part information generator 104 may generate spatial affected-part information on a region designated by the user (i.e., a specific region of the lungs in which pneumonia has occurred) in a patient body map. The medical patient information generator 106 may extract a medical term “inflammation” or “infection” from the additional information database 120 according to a command of the user, and then combine the spatial affected-part information with “inflammation” or “infection,” thereby generating a diagnosis “Inflammation or infection occurred in the specific part of the lungs as medical patient information. In this case, it is possible to accurately and minutely express a position in the lungs at which the inflammation has occurred and a size of the inflammation, and thus medical patient information can be minutely expressed with the development of diagnostic systems and medical science.

In other words, although it is possible to minutely check in which part of lungs pneumonia has occurred when a pneumonia patient is examined by CT scan, etc., pneumonia is expressed using only one medical code “J11” according to ICD 10 that is a conventional medical terminology system, and medical information in accordance with the development of diagnostic systems and medical science cannot be supported. On the other hand, in an exemplary embodiment of the present invention, medical patient information is generated by combining spatial affected-part information and additional information, and thus can be minutely expressed.

Meanwhile, there is no limit in a form in which data generated or used in an exemplary embodiment of the present invention (e.g., spatial affected-part information, medical patient information, and additional information) are stored in a database. When medical patient information is stored in the medical patient information database 137, all data of the medical patient information may be stored in one field of the database, or each element of the medical patient information may be stored in one field (or column) of the database. For example, in a physical examination and sign among exemplary embodiments of medical patient information, medical patient information may be classified into elements such as (1, 12, 123), map hu1213, wheezing sound, and sign. Here, the elements of the medical patient information may be stored in fields of the database respectively, or one or more elements (or all the elements) may be combined and stored a field of the database. A unique identification number (or code) may be given to each field of the database and may replace an element stored in the corresponding field.

The display 108 may display 2D images obtained by photographing a patient using a medical imaging system on the screen. Here, the patient body map generator 102 may generate a 3D patient body map by processing the plurality of 2D images according to an input made through the user interface 141 by a user. Also, the display 108 may display a body map extracted from the body map database 116 on the screen. Here, the patient body map generator 102 may generate a patient body map by modifying the body map according to the patient.

The display 108 may display a predetermined patient body map on the screen according to an input made through the user interface 141 by a user. At this time, the display 108 may display only a predetermined body region in the patient body map on the screen according to an input of the user. For example, when a user who is a vascular surgeon wants to see the abdominal aorta in a patient body map, if the small intestine is in front of the abdominal aorta, it is difficult to properly check blood vessels of the abdominal aorta. At this time, the display 108 may display only the abdominal aorta which is the body part that the user wants to see in the patient body map on the screen according to an input of the user. The display 108 may display only a body part corresponding to an anatomical name or a name of tissue input through the user interface 141 on the screen. The display 108 may display body parts set in advance according to a medical term on the screen. Also, when a user selects a stem of a predetermined layer from a hierarchy structure through the user interface 141, the display 108 may display only body parts corresponding to the stem on the screen.

In addition, the display 108 may display a patient body map on the screen at at least one view angle set in advance by a user. In other words, a user may previously set at least one view angle for a patient body map at which it is possible to properly check a predetermined affected region. Although it has been described here that a user sets a view angle in advance, a view angle is not limited to that has been set by a user in advance, and may have been set in advance by the system.

When a user selects the corresponding patient body map, the display 108 displays the patient body map on the screen at the view angle set for the patient body map. When there are several previously set view angles, the display 108 may simultaneously display the corresponding affected region on the screen at the several view angles. The system or the user may set the number of views and angles of the views for a medical term. When the medical term is input by a user, the display 108 may display the corresponding affected region on the screen according to the number of views and angles of the views set for the medical term.

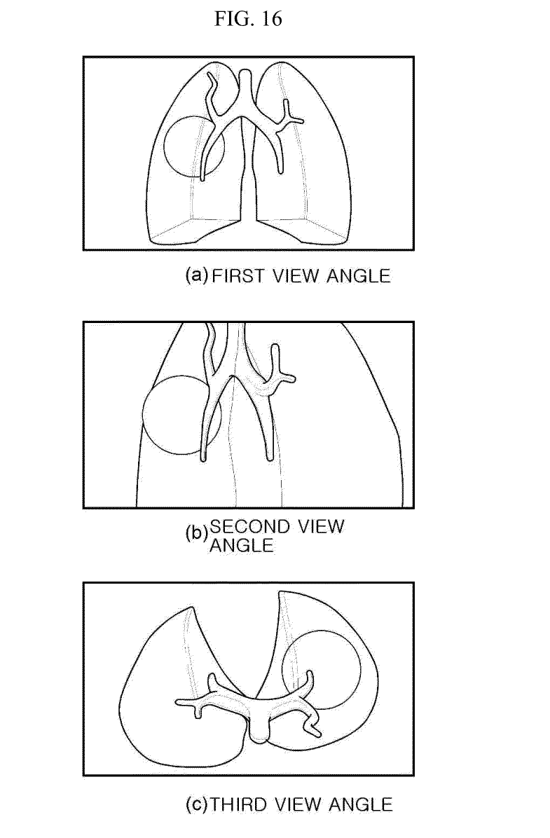

FIG. 16 shows diagrams of a patient body map displayed at view angles set for the patient body map on a screen by a display of the present invention.

Referring to FIG. 16, when a patient body map including lungs is displayed on the display 108, the display 108 may display the patient body map on the screen at various view angles (a first view angle, a second view angle, and a third view angle) as shown in (a), (b) and (c) of FIG. 16 according to a command of a user. Here, when it is determined that (a) of FIG. 16 is the best for checking a lesion in the lungs, a user may set a view angle (i.e., the first view angle) of (a) of FIG. 16 for the patient body map in advance. When a user selects the patient body map, the display 108 displays the patient body map on the screen at the view angle of (a) of FIG. 16. At this time, the display 108 may display only the lungs except for the ribs and heart in the patient body map on the screen according to a command of the user.

The display 108 may display spatial affected-part information generated by the spatial affected-part information generator 104 on the screen. The display 108 may display medical patient information generated by the medical patient information generator 106 on the screen. In this case, a user (e.g., a doctor) may see the medical patient information displayed on the screen and check a state of a patient. Here, since the spatial affected-part information is included in the medical patient information to minutely express an affected area of the patient, the doctor can more accurately understand a state of the patient. Also, the display may display search results of the searcher 110 on the screen.

When a user inputs a predetermined spatial body region, the searcher 110 extracts additional information mapped to the input spatial body region from the additional information database 120, and displays the extracted additional information on the screen. At this time, the user may input a calculation command for combining various search conditions through the user interface 141. Then, the searcher 110 may extract additional information according to a search condition input by the user from the additional information database 120, and displays the extracted additional information on the screen.

For example, when a doctor performs an operation on a predetermined affected region, it is necessary to check surrounding tissue, functions, complications, etc. affected by the operation. At this time, using a medical term (or medical code) of a conventional medical terminology system alone, it is impossible to check what surrounding tissue of the affected part is, but in an exemplary embodiment of the present invention, it is possible to check what surrounding tissue of the affected part is using spatial affected-part information. As an example, when the doctor designates an affected region requiring an operation and inputs surrounding tissue, functions, and complications affected by the operation as search conditions, the searcher 110 may extract additional information according to the search conditions from the additional information database 120 and display the extracted additional information on the screen, and the doctor may personally see and check the additional information.

In other words, when an operation is performed, organs around an affected part are generally exposed to a wider range than the affected part and may be damaged. At this time, the organs around the affected part may be checked by increasing a size of an affected-part space or enlarging a region of interest around the affected part, such that organs exposed upon the operation can be searched for. Also, using the searcher 110, surrounding tissue affected by the corresponding operation, complication following the operation, etc. may be searched for and displayed on the screen. In this case, the doctor cannot only check organs affected by the operation personally, but also can search for and display organs exposed upon the operation, functions of the organs, after-effects caused by damage of the organs, etc. on the screen. The doctor may designate and input a predetermined affected region through a patient body map. As another example, when the doctor inputs a predetermined affected region and an examination necessary for the affected region as search conditions, the searcher 110 may extract additional information according to the search conditions from the additional information database 120 and display the extracted additional information on the screen.

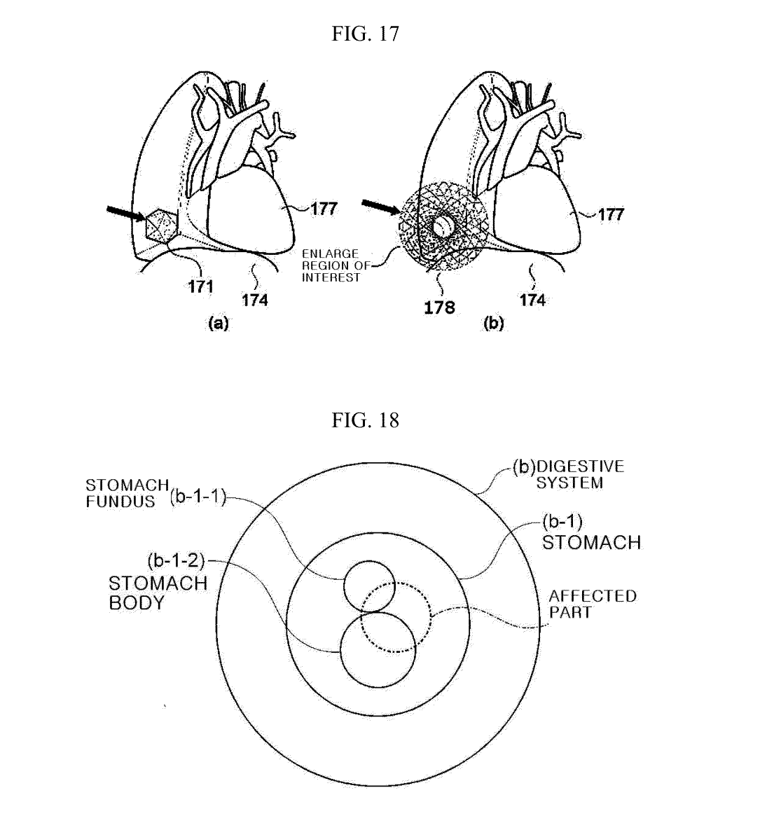

FIG. 17 is a diagram illustrating a state in which a searcher of the present invention enlarges a region of interest around an affected part to check an organ around the affected part.

Referring to FIG. 17, when a user wants to check a problem caused by removal of a tumor 171 arisen in a patient's lung, the user may enlarge a region of interest 178 around an affected part through the user interface 141. Here, when the user inputs surrounding tissue and complications affected by removal of the tumor 171 as search conditions, the searcher 110 may searches for information on parts corresponding to the region of interest 178, that is, a liver 174 under the tumor 171 and a heart 177 on a side of the tumor 171, and display the searched information on the screen. When it is searched that surgical complications or items to be confirmed before an operation have been mapped to a region of the liver 174 as reference information, the searcher 110 extracts the surgical complications or the items to be confirmed before the operation from the reference information database 127, and displays the extracted data on the screen.

In an exemplary embodiment of the present invention, additional information is mapped to affected regions presented using spatial coordinate information, and thus it is possible to know various types of additional information on any part of a bodily organ. For example, when a user wants to know an examination necessary to diagnose not a whole brain but a partial region of the brain, it is hard to accurately specify a part requiring a diagnosis in a conventional medical terminology system, and thus it is difficult to notify an examination necessary to diagnose the corresponding part. On the other hand, in an exemplary embodiment of the present invention, it is possible to accurately specify the part requiring a diagnosis from spatial affected-part information on the partial region of the brain. Also, since additional information is mapped to the spatial affected-part information, it is possible to readily notify an examination necessary to diagnose the corresponding part.

Besides this, it is possible to search for various types of additional information about whether a patient can receive insurance benefits for a predetermined affected region when the patient has various health insurances according to body parts, who is a famous medical specialist for a predetermined affected region, in which paper the latest operation method for a predetermined affected region has been introduced, what dietary supplements are helpful to cure a predetermined affected region and where the health foods are on sale, and so on. For example, when a certain patient having an arthritic knee joint designates surroundings of the knee as a region of interest, the searcher 110 may search the reference information database 127 for an address of a web page introducing glucosamine that helps the knee joint (http://somepage.com/info_page.asp?info_item=glucosamine) or an address of an Internet shopping mall selling glucosamine (http://someshops.com/item.html?item=glucosamine), and display the searched address on the screen or a linked screen of the corresponding web page.

The medical terminology converter 112 serves to convert medical patient information (including spatial affected-part information) into a medical term used in an existing medical terminology system. For example, in a case of transmitting medical patient information to an external device that employs only an existing medical terminology system, a case in which, to collect public health data, the government receives medical information using only medical terms in accordance with a conventional medical terminology system, and other cases, it is necessary to convert medical patient information into a medical term used in an existing medical terminology system.

FIG. 18 is a diagram schematically illustrating a state in which cancer has occurred in a part of the stomach among the digestive organs. Referring to FIG. 18, an affected region in which cancer has occurred partially overlaps a stomach fundus b-1-1 and a stomach body b-1-2 in a stomach b-1 among digestive organs b. In this case, medical patient information may be expressed as “spatial affected-part information+cancer.” Here, the medical terminology converter 112 may extract at least one of a medical term mapped to a spatial body region including the whole or a part of the affected region, a medical term mapped to a spatial body region adjacent to (in contact with or close to) the affected region, and a medical term mapped to a spatial body region excluding the affected region from the medical term database 125.

Specifically, the medical terminology converter 112 may extract medical terms mapped to the stomach fundus b-1-1 and the stomach body b-1-2 partially including the affected region from the medical terminology database 125. For example, the medical terminology converter 112 may extract C16.1 (ICD 10, malignant neoplasm of fundus of stomach), etc. that is a medical term related to the stomach fundus b-1-1. Also, the medical terminology converter 112 may extract C16.2 (ICD 10, malignant neoplasm of body of stomach), 808409018 (SNOMED CT, gastric corpus of structure), 835456017 (SNOMED, benign neoplasm of body of stomach), etc. that are medical terms related to the stomach body b-1-2. The medical terminology converter 112 may extract medical terms mapped to the stomach b-1 and the digestive organs b including the whole affected region from the medical terminology database 125. For example, the medical terminology converter 112 may extract medical terms C16.9 (ICD 10, malignant neoplasm of stomach, unspecified), 564471016 (SNOMED CT, entire stomach), etc. that are medical terms related to the stomach b-1. Also, the medical terminology converter 112 may extract medical terms 2468857012 (SNOMED CT, disorder of digestive system), K29.9 (ICD 10, diseases of digestive system, unspecified), etc. that are medical terms related to the digestive organs b.

Here, the medical terminology converter 112 may convert the medical patient information into one of the extracted medical terms (e.g., C16.1 (ICD 10, malignant neoplasm of bottom of stomach) or C16.2 (ICD 10, malignant neoplasm of body of stomach). For example, the medical terminology converter 112 may convert the medical patient information into a medical term selected by a user or a randomly selected medical term among the extracted medical terms.

At this time, the medical terminology converter 112 may select one of the extracted medical terms according to at least one of the degrees of dimensions (including height, width, length, and volume) of spatial regions mapped with the extracted medical terms and spatial relationships between the spatial regions mapped with the extracted medical terms and the affected region. For example, the medical terminology converter 112 may select a medical term mapped to a spatial region that overlaps the largest area of the affected region (i.e., a medical term mapped to the stomach body b-1-2) among the extracted medical terms.

Meanwhile, the medical terminology converter 112 may convert medical patient information into a medical term according to a conversion condition set by a user. Specifically, the medical terminology converter 112 may extract at least one of a medical term mapped to a spatial body region including the whole or a part of the affected region, a medical term mapped to a spatial body region adjacent to the affected region, and a medical term mapped to a spatial body region excluding the affected region from the medical term database 125, and then convert the medical patient information into a medical term that satisfies a conversion condition input by a user among the extracted medical terms. For example, the medical terminology converter 112 may select a medical term that satisfies a conversion condition of “cancer,” “malignant,” or “medical term beginning with C” (because medical codes of cancer begin with C in ICD 10) among the medical terms extracted from the medical term database 125, and convert the medical patient information into a medical term used in an existing medical terminology system.

The communicator 114 may transmit medical patient information to an external device. At this time, the communicator 114 may selectively transmit only spatial affected-part information in the medical patient information to the external device. The communicator 114 may transmit the spatial affected-part information itself to the external device, or transmit only information on an address or codes at which the corresponding spatial affected-part information is stored in the spatial affected-part information database 135 to the external device. In the latter case, the external device may access the spatial affected-part information database 135 using the address information received from the communicator 114, and extract the spatial affected-part information. Also, the communicator 114 may transmit a medical term converted by the medical terminology converter 112 to the external device. Here, the external device may be another electronic device in the hospital, or an electronic device installed in another hospital or another institution.

For example, when a body map has been used to generate spatial affected-part information on a predetermined patient, the communicator 114 may transmit a unique identification number (or code) of the corresponding standard body map to the external device together with medical patient information. At this time, the communicator 114 may transmit the corresponding standard body map itself to the external device. Also, when a patient body map generated from an image of a patient has been used to generate spatial affected-part information, the communicator 114 may transmit the patient body map to the external device together with medical patient information.

The medical patient information processor 115 may interpret previously generated medical patient information and display the interpreted medical patient information on the screen. Specifically, the medical patient information processor 115 may interpret spatial affected-part information in generated medical patient information, and extract a patient body map from which the affected-part information has been generated from the patient body map database 133. The medical patient information processor 115 may extract the patient body map using a unique identification number (or code) of the patient body map included in the spatial affected-part information. The medical patient information processor 115 may display the extracted patient body map on the screen, and then display an affected region corresponding to the spatial affected-part information. When the spatial affected-part information is a plurality of spaces combined by an operator, the medical patient information processor 115 may perform the corresponding calculation on the plurality of spaces and display the affected region. When a unique identification number (or code) has been given to the spatial affected-part information, the medical patient information processor 115 may extract information mapped to the unique identification number (or code) from the spatial affected-part information database 135 and display the affected region.

The medical patient information processor may modify previously generated medical patient information. When a state of a patient progresses after medical patient information is generated, the medical patient information processor 115 may modify the previously generated medical patient information. For example, when a tumor increases in size or inflammation gets worse after medical patient information is generated, the medical patient information processor 115 may modify the previously generated medical patient information according to the state of a patient. The medical patient information processor 115 may store the modified medical patient information in the medical patient information database 137.

In the body map database 116, body maps are stored according to sex (i.e., male or female), age, height (i.e., stature), residential district (or country), anatomical variation, and so on. Here, body maps of body parts as well as whole bodies may be stored in the body map database 116. Each body map may be matched with a unique identification number (or code) and stored.

The affected-part model database 118 stores an affected region having a fixed shape and size as an affected-part model for each disease or illness. Here, the affected-part model database 118 may store spatial information on an affected region having a shape and a size of an affected-part that is frequently observed from the corresponding disease or illness. Each affected-part model may be matched with a unique identification number (or code) and stored. An affected-part model may be mapped to at least one medical term and stored. In the affected-part model database 118, spatial data about a reference point representing each affected-part model may be matched with a unique identification number (or code) of the affected-part model and stored.

The additional information database 120 stores various types of additional information. The additional information database 120 includes the medical terminology database 125 and the reference information database 127. The medical terminology database 125 stores medical terms defined in existing medical terminology systems (e.g., ICD-9, ICD 10, UMLS, and SNOMED CT). The reference information database 127 stores information whereby a doctor or a patient can be aided in connection with a predetermined spatial body region. In the reference information database 127, reference information is mapped to a predetermined spatial body region and stored.

The patient database 122 stores information related to patients according to the respective patients. The patient database 122 includes the patient personal information database 131, the patient body map database 133, the spatial affected-part information database 135, and the medical patient information database 137. The patient personal information database 131 stores patient personal information (e.g., name, age, sex, height, weight, address, guardian name, social security number, email address, and chart number) according to the respective patients. The patient body map database 133 stores patient body maps according to the respective patients. The spatial affected-part information database 135 stores spatial affected-part information according to the respective patients. Here, in the spatial affected-part information database 135, spatial data about at least one reference point representing an affected region in accordance with each piece of spatial affected-part information may be mapped to the affected region and stored. As described above, the spatial affected-part information generator 104 may store generated spatial affected-part information in the affected-part model database 118, and thus the spatial affected-part information database 135 and the affected-part model database 118 may be implemented as one database device. The medical patient information database 137 stores medical patient information according to the respective patients.

In an exemplary embodiment of the present invention, medical patient information including spatial affected-part information on an affected region is generated, such that medical patient information that cannot be expressed using an existing medical terminology system can be accurately and minutely expressed. Accordingly, in the process of making a determination of a state of a patient, intervention of the subjectivity of a doctor is minimized, such that a relatively objective determination can be made.

Also, the ambiguity of medical patient information caused by conventional medical terminology systems can be reduced. Accordingly, it is possible to reduce misunderstandings occurring in the process of delivering medical patient information to another medical institution, and improve interoperability when medical patient information is exchanged between medical institutions.

In addition, medical patient information is generated by combining spatial affected-part information and a medical term, and thus it is possible to improve a medical information processing capability while complementing an existing medical terminology system.

Further, an exemplary embodiment of the present invention can be used as a complement to or in replacement of an existing medical terminology system to exchange information between doctors, hospitals, countries, and so on. In this case, it is possible to reduce the efforts to convert an existing anatomical concept into sementics-based medical codes, and also medical information that is difficult to express with medical terminology or codes can be expressed without constraint.

Moreover, by mapping additional information (medical terminology and reference information) to a predetermined affected region and storing the additional information together with the affected region, a medical information processing system can be caused to exhibit artificial intelligence (AI) on the basis of various calculations, and a determination capability of the AI can be improved. In other words, since it is possible to express distance between bodily organs or pieces of bodily tissue in a body region, size of an affected part, whether or not a predetermined bodily organ or predetermined bodily tissue is included in an affected region, etc. using spatial affected-part information, an AI having various ways of logic can be implemented.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for processing medical information, comprising:
a spatial affected-part information generator configured to generate spatial affected-part information on a region designated by a user in a patient body map; and
a medical patient information generator configured to generate medical patient information including the spatial affected-part information.

2. The system of claim 1, further comprising an additional information database including at least one of a medical terminology database configured to store medical terms and a reference information database configured to store reference information,
wherein the medical patient information generator generates the medical patient information by combining at least one of medical terms and reference information extracted from the additional information database with the spatial affected-part information.

3. The system of claim 2, wherein the medical patient information generator expresses a concept of at least one of an anatomical position, size and shape of an affected part among of meanings of the medical patient information using the spatial affected-part information, and expresses concepts of the medical patient information other than the anatomical position, size and shape of the affected part using the additional information extracted from the additional information database.

4. The system of claim 2, wherein the medical terms and the reference information are mapped to a predetermined spatial body region and stored in the medical terminology database and the reference information database, respectively.

5. The system of claim 4, further comprising a searcher configured to extract at least one of the medical terms and the reference information mapped to the spatial body region input by the user from the additional information database.

6. The system of claim 4, wherein information on one of the spatial body regions mapped with the medical terms is extracted in at least one of the occasions when it includes a part or the whole of an affected region, when it is adjacent to the affected region, and when it is a region excluding the affected region.

7. The system of claim 2, further comprising a medical terminology converter configured to convert the medical patient information generated by the medical patient information generator into the medical terms.

8. The system of claim 7, wherein the medical terms are mapped to a predetermined spatial body region and stored in the medical terminology database, and
the medical terminology converter extracts at least one of a medical term mapped to a spatial body region including the whole or a part of an affected region corresponding to the spatial affected-part information in the medical patient information, a medical term mapped to a spatial body region adjacent to the affected region, and a medical term mapped to a spatial body region excluding the affected region from the medical terminology database.

9. The system of claim 7, wherein the medical terminology converter converts the medical patient information into any one of the extracted medical terms according to degrees of dimensions of spatial body regions mapped with the extracted medical terms or spatial relationships between the spatial body regions mapped with the medical terms and an affected part.

10. The system of claim 7, wherein the medical terminology converter converts the medical patient information into a medical term satisfying a conversion condition input by the user among the extracted medical terms.

11. The system of claim 1, further comprising a body map database configured to store body maps,
wherein the medical patient information generator extracts a body map corresponding to patient information including at least one of sex, age, height, residential district, and anatomical variation of a patient from the body map database, and then generates the medical patient information according to results of a comparison between the spatial affected-part information on an affected part of the patient and spatial information on a body region corresponding to the affected part in the extracted body map.

12. The system of claim 1, wherein the spatial affected-part information includes at least one of spatial information on an affected region resulting from performing a calculation command of a user for at least one body region designated by the user in the patient body map, and an operation expression in accordance with the calculation command of the user.

13. The system of claim 1, further comprising an affected-part model database configured to store affected-part models,
wherein the spatial affected-part information generator extracts an affected-part model selected by the user from the affected-part model database, and then generates the spatial affected-part information from a spatial region of the extracted affected-part model or a spatial region obtained by modifying the extracted affected-part model.

14. The system of claim 1, wherein the spatial affected-part information generator generates the spatial affected-part information on a figure input by the user in the patient body map, a combination of two or more figures input by the user, or a region presented using a relationship between the two or more figures.

15. The system of claim 1, wherein the spatial affected-part information generator generates the spatial affected-part information by substituting a region designated by the user in a two-dimensional (2D) patient body map with three-dimensional (3D) spatial coordinates.

16. The system of claim 1, further comprising a display configured to display at least one of the spatial affected-part information and the medical patient information on a screen,
wherein the display displays the patient body map on the screen at at least one view angle previously set for the patient body map according to an input of the user or a medical term.

17. The system of claim 1, further comprising a display configured to display at least one of the spatial affected-part information and the medical patient information on a screen,
wherein the display displays only previously set organs in the patient body map on the screen according to an input of the user or a medical term.

18. The system of claim 1, further comprising a communicator configured to transmit the medical patient information to an external device.

19. The system of claim 1, further comprising a patient body map generator configured to generate the patient body map on a predetermined patient.

20. The system of claim 19, further comprising a body map database configured to store body maps,
wherein the patient body map generator generates the patient body map by extracting a body map corresponding to patient information including sex, age, height, residential district, and anatomical variation of the patient from the body map database, modifying the extracted body map according to the patient, or combining several extracted body maps.

21. The system of claim 20, wherein the body maps are matched with unique identification numbers or codes and stored in the body map database.

22. The system of claim 1, further comprising a medical patient information processor configured to interpret or modify the medical patient information generated by the medical patient information generator.

23. The system of claim 1, wherein a unique identification number or code is given to a part or the whole of the medical patient information, and is mapped to content of the medical patient information corresponding to the unique identification number or code.
